(19) United States
(12) Patent Application Publication
(10) Pub. No.: US 2012/0035301 A1
(43) Pub. Date: Feb. 9, 2012

(54) Method For The Production Of Copolymers

(76) Inventors: Mario Vierle, Wasserburg (DE); Christian Scholz, Wald an der Alz (DE)

(21) Appl. No.: 13/133,047

(22) PCT Filed: Jan. 13, 2009
(86) PCT No.: PCT/EP2009/050290

§ 371 Date: Oct. 14, 2011

(30) Foreign Application Priority Data
Dec. 8, 2008 (EP) 08170972.7

(51) Int. Cl. C08F 222/06; C08K 3/00

(52) U.S. Cl. 524/5; 526/271

(57) ABSTRACT

The invention relates to a process for the preparation of a copolymer in semicontinuous operation in a polymerization apparatus, comprising a polymerization reactor connected to a metering device, in each case acid monomer being initially taken in the metering device and polyether macromonomer and water in the polymerization reactor, acid monomer being metered from the metering device into the polymerization reactor, free radical polymerization initiator being passed into the polymerization reactor before and/or during the metering of the acid monomer into the polymerization reactor so that an aqueous medium in which acid monomer and polyether macromonomer are reacted with formation of the copolymer by free radical polymerization forms in the polymerization reactor, the free radical polymerization initiator used being an H₂O₂— or alkali metal peroxodisulphate-containing redox initiator system, the temperature of the aqueous medium during the polymerization being adjusted to 5 to 43° C., the temperature of the aqueous medium being not more than 28° C. at the beginning of the polymerization, altogether 1 to 20 mol of acid monomer being metered into the polymerization reactor per mole of polyether macromonomer used, the weight ratio of polyether macromonomer used to water used being 5:1 to 1:5, at least 70% by weight of the water initially taken in the polymerization reactor being provided in the manner such that it is either added to the polymerization reactor at a temperature of not more than 19° C. or it is combined with the polyether macromonomer before it is added to the polymerization reactor and thus has a temperature of not more than 19° C.

The present invention relates to a process for the preparation of a copolymer, the copolymer and the use of the copolymer.

It is known that admixtures in the form of dispersants are often added to aqueous slurries of pulverulent inorganic or organic substances, such as clays, silicate powder, chalk, carbon black, crushed rock and hydraulic binders, for improving their processability, i.e. kneadability, spreadability, sprayability, pumpability or flowability. Such admixtures are capable of breaking up solid agglomerates, of dispersing the particles formed and in this way of improving the processability. This effect is utilized also in a targeted manner in particular in the preparation of building material mixtures which contain hydraulic binders, such as cement, lime, gypsum or anhydrite.

In order to convert these building material mixtures based on said binders into a ready-to-use, processable form, as a rule substantially more mixing water is required than would be necessary for the subsequent hydration or hardening process. The portion of cavities formed in the concrete body as a result of the excess, subsequently evaporating water leads to significantly poorer mechanical strengths and stabilities.

In order to reduce this excess proportion of water at a specified processing consistency and/or to improve the processability at a specified water/binder ratio, admixtures which are generally referred to as water-reducing agents or superplasticizers are used. Agents of this type which are used in practice are in particular copolymers which are prepared by free radical copolymerization of acid monomers with polyether macromonomers.

In practice, the copolymerization is generally effected by the semibatch procedure. WO 2005/075529 describes a semicontinuous process for the preparation of said copolymers, in which the polyether macromonomer is initially taken and the acid monomer is then metered in to the initially taken mixture over time. Although the process described is already economical and high-performance superplasticizers are obtained as a product of the process, there is still an aspiration to improve the cost-efficiency of the process and quality of the product of the process even further.

The object of the present invention is therefore to provide an economical process for the preparation of copolymers which show good performance as dispersants for hydraulic binders, especially as superplasticizers.

This object is achieved by a process for the preparation of a copolymer in semicontinuous operation in a polymerization apparatus, comprising a polymerization reactor connected to a metering device, in each case acid monomer being initially taken in the metering device and polyether macromonomer and water in the polymerization reactor, acid monomer being metered from the metering device into the polymerization reactor, free radical polymerization initiator being passed into the polymerization reactor before and/or during the metering of the acid monomer into the polymerization reactor so that an aqueous medium in which acid monomer and polyether macromonomer are reacted with formation of the copolymer by free radical polymerization forms in the polymerization reactor, an H₂O₂— or alkali metal peroxodisulphate-containing redox initiator system being used as the free radical polymerization initiator, the temperature of the aqueous medium during the polymerization being adjusted to 5 to 43° C., the temperature of the aqueous medium being not more than 28° C. at the beginning of the polymerization, altogether 1 to 20 mol of acid monomer being metered into the polymerization reactor per mole of polyether macromonomer used, the weight ratio of polyether macromonomer used to water used being 5:1 to 1:5, at least 70% by weight of the water initially taken in the polymerization reactor being provided in a manner such that it is either added to the polymerization reactor at a temperature of not more than 19° C. or that it is combined with the polyether macromonomer before it is added to the polymerization reactor and thus has a temperature of not more than 19° C.

Acid monomer is to be understood as meaning monomers which are capable of free radical copolymerization, have at least one carbon double bond, contain at least one acid function and react as an acid in an aqueous medium. Furthermore, acid monomer is also to be understood as meaning monomers which are capable of free radical polymerization, have at least one carbon double bond and, owing to a hydrolysis reaction in an aqueous medium, form at least one acid function and react as an acid in the aqueous medium (example: maleic anhydride or base-hydrolysable esters, such as ethyl acrylate). In the context of the present invention, polyether macromonomers are compounds which are capable of free radical copolymerization and have at least one carbon double bond and at least two ether oxygen atoms, in particular with the proviso that the polyether macromonomer structural units present in the copolymer have side chains which contain at least two ether oxygen atoms.

The consistency of the polyether macromonomers described at room temperature is mainly dependent on the molar mass. In virtually all cases, these polyether macromonomers are present as a solid at room temperature. Since metering of solids in industrial processes is generally more complicated than metering of liquids and the dissolution rate of the polyether macromonomers present in solid form decreases substantially with increasing molar mass, the macromonomer is in most cases handled as a melt. Since an aqueous solution of the polyether macromonomer is prepared in the first step of the polymer synthesis, the temperature of the solution which is established by mixing of the polyether macromonomer present as a melt with water is very high in many cases and must be reduced by cooling to the starting temperature. However, the cooling time to be used increases the batchtime.

Because relatively cool water is provided in the process according to the invention, there is no need for cooling times for starting materials or corresponding cooling times are reduced. From the point of view of process engineering, an improvement of the so-called space-time yield is associated with the reduction or the absence of the cooling time, with the result that more batches are possible by unit times. This results in a substantial improvement in the cost-efficiency.

In a particularly preferred embodiment of the invention, the at least 70% by weight of the water which is initially taken in the polymerization reactor and is provided is taken from naturally occurring ground or surface water (e.g. river water), preferably ground water.

During cooling of the macromonomer solution by external cooling, it is furthermore necessary to use a considerable amount of energy. Owing to a lower temperature resulting after mixing of the macromonomer present as a melt with relatively cool water, cooling energy can be saved in this way, with the result that the cost-efficiency is even further improved.

Normally, the temperature of the aqueous medium during the polymerization is adjusted to 10 to 38° C., the temperature of the aqueous medium then being not more than 24° C. at the beginning of the polymerization, and at least 80% by weight of the water initially taken in the polymerization reactor being provided in cooled form in a manner such that it is either added to the polymerization reactor at a temperature of 2 to 17° C. or that it is combined with the polyether macromonomer before it is added to the polymerization reactor and thus has a temperature of 2 to 17° C.

Preferably, the reaction of the acid monomer produces in the copolymer a structural unit which is according to the general formulae (Ia), (Ib), (Ic) and/or (Id)

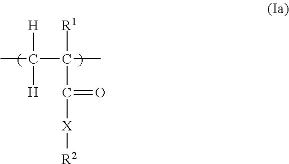

where
R¹ is identical or different and is represented by H and/or a straight-chain or branched C₁-C₄ alkyl group;
X is identical or different and is represented by NH—(CₙH₂ₙ) where n=1, 2, 3 or 4 and/or O—(CₙH₂ₙ) where n=1, 2, 3 or 4 and/or by a unit not present;
R² is identical or different and is represented by OH, SO₃H, PO₃H₂, O—PO₃H₂ and/or para-substituted C₆H₄—SO₃H, with the proviso that, if X is a unit not present, R² is represented by OH;

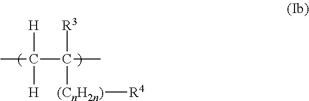

where
R³ is identical or different and is represented by H and/or a straight-chain or branched C₁-C₄ alkyl group;
n=0, 1, 2, 3 or 4;
R⁴ is identical or different and is represented by SO₃H, PO₃H₂, O—PO₃H₂ and/or C₆H₄—SO₃H present in para-substituted form;

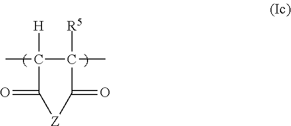

where
R⁵ is identical or different and is represented by H and/or a straight-chain or branched C₁-C₄ alkyl group;
Z is identical or different and is represented by O and/or NH;

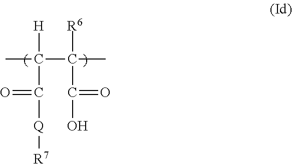

where
R⁶ is identical or different and is represented by H and/or a straight-chain or branched C₁-C₄ alkyl group;
Q is identical or different and is represented by NH and/or O;
R⁷ is identical or different and is represented by H, (CₙH₂ₙ)—SO₃H where n=0, 1, 2, 3 or 4, (CₙH₂ₙ)—OH where n=0, 1, 2, 3 or 4; (CₙH₂ₙ)—PO₃H₂ where n=0, 1, 2, 3 or 4, (CₙH₂ₙ)—OPO₃H₂ where n=0, 1, 2, 3 or 4, (C₆H₄)—SO₃H, (C₆H₄)—PO₃H₂, (C₆H₄)—OPO₃H₂ and/or (CₘH₂ₘ)ₑ—O-(A′O)_{α}—R⁹ where m=0, 1, 2, 3 or 4, e=0, 1, 2, 3 or 4, A′=C_{x′}H_{2x′} where x′=2, 3, 4 or 5 and/or CH₂C(C₆H₅)H—, α=an integer from 1 to 350 with R⁹ identical or different and represented by a straight-chain or branched C₁-C₄ alkyl group.

Frequently, the acid monomer used is methacrylic acid, acrylic acid, maleic acid, maleic anhydride, a monoester of maleic acid and a mixture of a plurality of these components.

Depending on the pH, the acid monomer structural units of the copolymer can also be present in deprotonated form as a salt, in which Na⁺, K⁺ and Ca²⁺ are typical as counterions.

As a rule, a structural unit is produced in the copolymer by the reaction of the polyether macromonomer, which structural unit is according to one of the general formulae (IIa), (IIb) and/or (IIc)

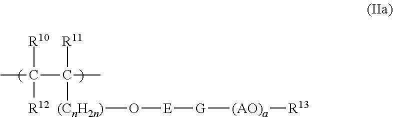

where
R¹⁰, R¹¹ and R¹² are in each case identical or different and, independently of one another, are represented by H and/or a straight-chain or branched C₁-C₄ alkyl group;
E is identical or different and is represented by a straight-chain or branched C₁-C₆ alkylene group, a cyclohexyl group, CH₂—C₆H₁₀, C₆H₄ present in ortho-, meta- or para-substituted form and/or a unit not present;
G is identical or different and is represented by O, NH and/or CO—NH, with the proviso that, if E is a unit not present, G is also present as a unit not present;
A is identical or different and is represented by CₓH₂ₓ where x=2, 3, 4 and/or 5 (preferably x=2) and/or CH₂CH(C₆H₅);
n is identical or different and is represented by 0, 1, 2, 3, 4 and/or 5;
a is identical or different and is represented by an integer from 2 to 350 (preferably 10-200);
R¹³ is identical or different and is represented by H, a straight-chain or branched C₁-C₄ alkyl group, CO—NH₂, and/or COCH₃;

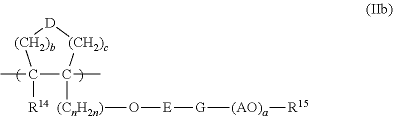

where
R¹⁴ is identical or different and is represented by H and/or a straight-chain or branched C₁-C₄ alkyl group;
E is identical or different and is represented by a straight-chain or branched C₁-C₆ alkylene group, a cyclohexyl group, CH₂—C₆H₁₀, C₆H₄ present in ortho-, meta- or para-substituted form and/or by a unit not present;
G is identical or different and is represented by a unit not present, O, NH and/or CO—NH, with the proviso that, if E is a unit not present, G is also present as a unit not present;
A is identical or different and is represented by CₓH₂ₓ where x=2, 3, 4 and/or 5 and/or CH₂CH(C₆H₅);
n is identical or different and is represented by 0, 1, 2, 3, 4 and/or 5;
a is identical or different and is represented by an integer from 2 to 350;
D is identical or different and is represented by a unit not present, NH and/or O, with the proviso that if D is a unit not present: b=0, 1, 2, 3 or 4 and c=0, 1, 2, 3 or 4, where b+c=3 or 4, and with the proviso that if D is NH and/or O: b=0, 1, 2 or 3, c=0, 1, 2 or 3, where b+c=2 or 3;
R¹⁵ is identical or different and is represented by H, a straight-chain or branched C₁-C₄ alkyl group, CO—NH₂, and/or COCH₃;

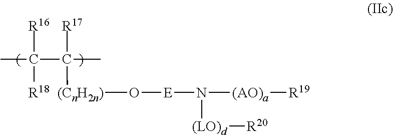

where
R¹⁶, R¹⁷ and R¹⁸ in each case are identical or different and, independently of one another, are represented by H and/or a straight-chain or branched C₁-C₄ alkyl group;
E is identical or different and is represented by a straight-chain or branched C₁-C₆ alkylene group, a cyclohexyl group, CH₂—C₆H₁₀ and/or C₆H₄ present in ortho-, meta- or para-substituted form;
A is identical or different and is represented by CₓH₂ₓ where x=2, 3, 4 and/or 5 and/or CH₂CH(C₆H₅);
n is identical or different and is represented by 0, 1, 2, 3, 4 and/or 5;
L is identical or different and is represented by CₓH₂ₓ where x=2, 3, 4 and/or 5 and/or CH₂—CH(C₆H₅);
a is identical or different and is represented by an integer from 2 to 350;
d is identical or different and is represented by an integer from 1 to 350;
R¹⁹ is identical or different and is represented by H and/or a straight-chain or branched C₁-C₄ alkyl group,
R²⁰ is identical or different and is represented by H and/or a straight-chain C₁-C₄ alkyl group.

Frequently, the polyether macromonomer used is alkoxylated hydroxybutyl vinyl ether and/or alkoxylated diethylene glycol monovinyl ether and/or alkoxylated isoprenol and/or alkoxylated (meth)allyl alcohol and/or vinylated methylpolyalkylene glycol having preferably in each case an arithmetic mean number of 4 to 300 oxyalkylene groups.

The alkoxy units of the polyether macromonomers are as a rule present as ethoxy groups or as a mixture of ethoxy and propoxy groups (these polyether macromonomers are obtainable from the ethoxylation or propoxylation of the corresponding monomer alcohols).

As a rule, the free radical polymerization initiator used is an H₂O₂— or alkali metal peroxodisulphate-containing redox initiator system which is used together with a reducing agent, the reducing agent preferably being present in the form of sodium sulphite, disodium salt of 2-hydroxy-2-sulphinatoacetic acid, disodium salt of 2-hydroxy-2-sulphonatoacetic acid, sodium hydroxymethanesulphinate, ascorbic acid and/or isoascorbic acid, the temperature of the aqueous medium during the polymerization being adjusted to 5 to 43° C. and the temperature of the aqueous medium being not more than 28° C. at the beginning of the polymerization.

Preferably, the aqueous medium is present in the form of an aqueous solution.

In general, at least 45 mol %, preferably at least 80 mol %, of all structural units of the copolymer are produced by incorporation of acid monomer and polyether macromonomer in the form of polymerized units.

Often, a chain-transfer agent, which normally contains at least one thiol group, is used.

The invention additionally relates to a copolymer which can be prepared by the process described above.

The invention furthermore relates to the use of this copolymer as a dispersant for hydraulic binders and/or for latently hydraulic binders. The copolymer according to the invention can also be used for example (in particular in dewatered form) as an additive for cement production (grinding aid and “water reducer” for pure Portland cements or composite cements).

The invention is to be illustrated in more detail below with reference to working examples.

### SYNTHESIS EXAMPLES

### Polymer 1

336 g of water having a temperature of 15.0° C. and 348.00 g of vinyloxybutylpoly-ethylene glycol (adduct of 129 mol of ethylene oxide with 4-hydroxybutylmonovinyl ether) present as a melt at a temperature of 80° C. are initially taken in a double-walled reactor equipped with stirrer, pH electrode and a plurality of feed devices. A mixing temperature of 42.0° C. results. The reactor content is then cooled to a temperature of 25.0° C., and the circulation temperature of the cooling medium is a constant 13.0° C. thereby.

In a separate feed vessel, 17.60 g of acrylic acid and 3.41 g of maleic anhydride are homogeneously mixed with 61.07 g of deionized water, and 7.83 g of a 40% strength potassium hydroxide solution are added with cooling.

At the same time, a second solution consisting of 1.08 g of Brüggolit® FF6 (commercial product from Brüggemann Chemicals GmbH) and 17.00 g of water (solution B) is prepared.

After cooling of the initially taken mixture to 25.0° C. is complete (15 min after addition of the vinyloxybutylpolyethylene glycol melt), 42.50 ml of solution A and 3.90 g of 20% strength sodium hydroxide solution and 0.21 g of 3-mercaptopropionic acid are added to the initially taken mixture. Thereafter, 1.88 g of 3-mercaptopropionic acid are added to the remaining solution A, after which 0.12 g of iron(II) sulphate heptahydrate and 2.00 g of hydrogen peroxide (30% in water) are added to the initially taken mixture and the reaction is started. Simultaneously, the addition of solution A and solution B to the stirred initially taken mixture is begun.

The metering rates of solution A can be seen from the following metering profile. Solution B is metered into the reactor at a constant metering rate up to the end of the metering of solution A.

| | t (min) | | | | | | | | | | | |
|---|---|---|---|---|---|---|---|---|---|---|---|---|
| | 0 | 2 | 4 | 8 | 10 | 12 | 14 | 16 | 18 | 22 | 26 | 30 |
| Solution A | 129 | 144 | 149 | 144 | 129 | 106 | 87 | 69 | 54 | 33 | 21 | 0 |
| (ml/h) | | | | | | | | | | | | |

After the end of the reaction, the polymer solution obtained is adjusted to a pH of 6.5 with 20% strength sodium hydroxide solution.

A slightly yellowish polymer solution is obtained; the copolymer has a mass average molecular weight of 53 000 g/mol.

### Polymer 2

Polymer 2 is synthesized analogously to polymer 1, the temperature of the water used being 25.0° C. in the preparation of the mixture of vinyloxybutylpolyethylene glycol with water. A mixing temperature of 48.5° C. results; the time up to cooling of the aqueous solution to 25.0° C. is 17 minutes. In a manner analogous to the preparation of polymer 1, a slightly yellowish polymer solution is obtained; the copolymer has a mass average molecular weight of 53 500 g/mol.

Below, the temperature and time differences are shown again in the form of a table:

| | Water | Mixing | Cooling time |
|---|---|---|---|
| | temperature | temperature | to 25.0° C. |
| Polymer 1 | 15.0° C. | 42.0° C. | 15 min |
| Polymer 2 | 25.0° C. | 48.5° C. | 17 min |

In the preparation of polymer 2, in which water at a temperature of 25° C. was used, the mixing temperature is substantially higher and hence the cooling time is substantially longer and the energy required for cooling the mixture is substantially higher. Below, the data on the performance characteristics of the polymers are to be illustrated in more detail:

400 kg of Portland cement (CEM I 42.5 R) were stirred with round aggregates composed, according to the Fuller grading curve, with particles having a maximum size of 16 mm and 140 kg of water which contained the products according to the invention in dissolved form. Immediately after the preparation of the concrete mix, the determination of the fresh concrete properties and the change thereof as a function of time over a period of 30 minutes were determined.

The results of the test are shown in the table below

| | | | | | | Compressive |
|---|---|---|---|---|---|---|
| Super- | | Slump² in cm | | | Air pore | strength |
| plasticizer | Dose¹ | 0 min | 10 min | 30 min | content/% | 24 h/MPa |
| Polymer 1 | 0.14% | 58 | 37 | 32 | 2.4% | 54.0 |
| Polymer 2 | 0.14% | 58 | 38 | 32 | 2.5% | 53.5 |

¹Dose in % by weight of poymer solid, based on the weight of cement taken,
²Determination according to DIN EN 12350-5

From the above results, it is clear that polymer 1 and polymer 2 have identical performance characteristics within the accuracy of measurement and the economic advantage with the use of cool spring water and the synthesis of polymer 1 is not minimized by a deterioration in the performance characteristics.

1. Process for the preparation of a copolymer in semicontinuous operation in a polymerization apparatus, comprising a polymerization reactor connected to a metering device, in each case acid monomer being initially taken in the metering device and polyether macromonomer and water in the polymerization reactor, acid monomer being metered from the metering device into the polymerization reactor, free radical polymerization initiator being passed into the polymerization reactor before and/or during the metering of the acid monomer into the polymerization reactor so that an aqueous medium in which acid monomer and polyether macromonomer are reacted with formation of the copolymer by free radical polymerization forms in the polymerization reactor, an H₂O₂— or alkali metal peroxodisulphate-containing redox initiator system being used as the free radical polymerization initiator, the temperature of the aqueous medium during the polymerization being adjusted to 5 to 43° C., the temperature of the aqueous medium being not more than 28° C. at the beginning of the polymerization, altogether 1 to 20 mol of acid monomer being metered into the polymerization reactor per mole of polyether macromonomer used, the weight ratio of polyether macromonomer used to water used being 5:1 to 1:5, at least 70% by weight of the water initially taken in the polymerization reactor being provided in a manner such that it is either added to the polymerization reactor at a temperature of not more than 19° C. or that it is combined with the polyether macromonomer before it is added to the polymerization reactor and thus has a temperature of not more than 19° C.

2. Process according to claim 1, wherein the at least 70% by weight of the water which is initially taken in the polymerization reactor and is provided is taken from naturally occurring ground or surface water.

3. Process according to claim 1, wherein the temperature of the aqueous medium during the polymerization is adjusted to 10 to 38° C. and the temperature of the aqueous medium is not more than 24° C. at the beginning of the polymerization, and at least 80% by weight of the water initially taken in the polymerization reactor is provided in cooled form in a manner such that it is either added to the polymerization reactor at a temperature of 2 to 17° C. or that it is combined with the polyether macromonomer before it is added to the polymerization reactor and thus has a temperature of 2 to 17° C.

4. Process according to claim 1, wherein a structural unit is produced in the copolymer by the reaction of the acid monomer, which structural unit is according to one of the general formulae (Ia), (Ib), (Ic) and/or (Id) 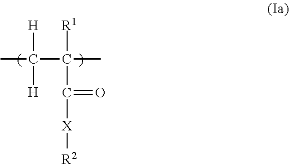
where
R¹ is identical or different and is represented by H and/or a straight-chain C₁-C₄ alkyl group or a branched C₃-C₄ alkyl group;
X is identical or different and is represented by NH—(CₙH₂ₙ) where n=1, 2, 3 or 4 and/or O—(CₙH₂ₙ) where n=1, 2, 3 or 4 and/or by a unit not present;
R² is identical or different and is represented by OH, SO₃H, PO₃H₂, O—PO₃H₂ and/or para-substituted C₆H₄—SO₃H, with the proviso that, if X is a unit not present, R² is represented by OH; 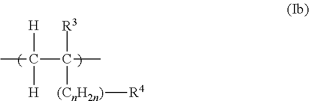
where
R³ is identical or different and is represented by H and/or a straight-chain C₁-C₄ alkyl group or a branched C₃-C₄ alkyl group;
n=0, 1, 2, 3 or 4;
R⁴ is identical or different and is represented by SO₃H, PO₃H₂, O—PO₃H₂ and/or C₆H₄—SO₃H present in para-substituted form; 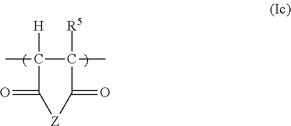
where
R⁵ is identical or different and is represented by H and/or a straight-chain C₁-C₄ alkyl group or a branched C₃-C₄ alkyl group;
Z is identical or different and is represented by 0 and/or NH; 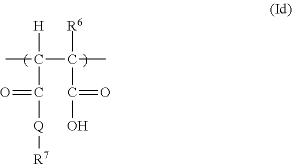
where
R⁶ is identical or different and is represented by H and/or a straight-chain C₁-C₄ alkyl group or a branched C₃-C₄ alkyl group;
Q is identical or different and is represented by NH and/or O;
R⁷ is identical or different and is represented by H, (CₙH₂ₙ)—SO₃H where n=0, 1, 2, 3 or 4, (CₙH₂ₙ)—OH where n=0, 1, 2, 3 or 4; (CₙH₂ₙ)—PO₃H₂ where n=0, 1, 2, 3 or 4, (CₙH₂ₙ)—OPO₃H₂ where n=0, 1, 2, 3 or 4, (C₆H₄)—SO₃H, (C₆H₄)—PO₃H₂, (C₆H₄)—OPO₃H₂ and/or (CₘH₂ₘ)ₑ—O-(A′O)_{α}—R⁹ where m=0, 1, 2, 3 or 4, e=0, 1, 2, 3 or 4, A′=C_{x′}H_{2x′} where x′=2, 3, 4 or 5 and/or CH₂C(C₆H₅)H—, α=an integer from 1 to 350 with R⁹ identical or different and represented by a straight-chain C₁-C₄ alkyl group or a branched C₃-C₄alkyl group.

5. Process according to claim 1, wherein the acid monomer used is methacrylic acid, acrylic acid, maleic acid, maleic anhydride, a monoester of maleic acid or a mixture of a plurality of these components.

6. Process according to claim 1, wherein a structural unit is produced in the copolymer by the reaction of the polyether macromonomer, which structural unit is according to one of the general formulae (IIa), (IIb) and/or (IIc) 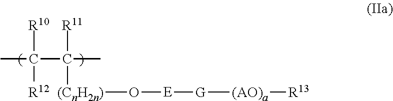
where
R¹⁰, R¹¹ and R¹² are in each case identical or different and, independently of one another, are represented by H and/or a straight-chain C₁-C₄ alkyl group or a branched C₃-C₄ alkyl group;
E is identical or different and is represented by a straight-chain C₁-C₆ alkylene group or branched C₃-C₆ alkylene group, a cyclohexyl group, CH₂—C₆H₁₀, C₆H₄ present in ortho-substituted C₆H₄, meta-substituted C₆H₄ or para-substituted form and/or a unit not present;
G is identical or different and is represented by O, NH and/or CO—NH, with the proviso that, if E is a unit not present, G is also a unit not present;
A is identical or different and is represented by CₓH₂ₓ where x=2, 3, 4 and/or 5 and/or CH₂CH(C₆H₅);
n is identical or different and is represented by 0, 1, 2, 3, 4 and/or 5;
a is identical or different and is represented by an integer from 2 to 350;
R¹³ is identical or different and is represented by H, a straight-chain C₁-C₄ alkyl group or a branched C₃-C₄ alkyl group, CO—NH₂, and/or COCH₃; 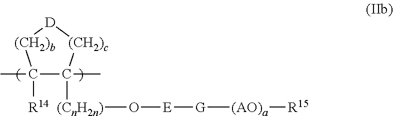
where
R¹⁴ is identical or different and is represented by H and/or a straight-chain C₁-C₄ alkyl group or a branched C₃-C₄ alkyl group;
E is identical or different and is represented by a straight-chain C₁-C₆ alkylene group or branched C₃-C₆ alkylene group, a cyclohexyl group, CH₂—C₆H₁₀, C₆H₄ present in ortho-substituted C₆H₄, meta-substituted C₆H₄ or para-substituted form and/or by a unit not present;
G is identical or different and is represented by a unit not present, O, NH and/or CO—NH, with the proviso that, if E is a unit not present, G is also a unit not present;
A is identical or different and is represented by CₓH₂ₓ where x=2, 3, 4 and/or 5 and/or CH₂CH(C₆H₅);
n is identical or different and is represented by 0, 1, 2, 3, 4 and/or 5;
a is identical or different and is represented by an integer from 2 to 350;
D is identical or different and is represented by a unit not present, NH and/or O, with the proviso that if D is a unit not present: b=0, 1, 2, 3 or 4 and c=0, 1, 2, 3 or 4, where b+c=3 or 4, and with the proviso that if D is NH and/or O: b=0, 1, 2 or 3, c=0, 1, 2 or 3, where b+c=2 or 3;
R¹⁵ is identical or different and is represented by H, a straight-chain C₁-C₄ alkyl group or a branched C₃-C₄ alkyl group, CO—NH₂, and/or COCH₃; 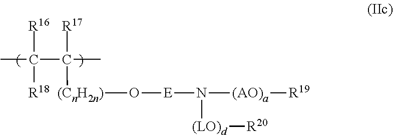
where
R¹⁶, R¹⁷ and R¹⁸ in each case are identical or different and, independently of one another, are represented by H and/or a straight-chain C₁-C₄ alkyl group or a branched C₃-C₄ alkyl group;
E is identical or different and is represented by a straight-chain C₁-C₆ alkylene group or branched C₃-C₆ alkylene group, a cyclohexyl group, CH₂—C₆H₁₀ and/or C₆H₄ present in ortho-substituted C₆H₄, meta-substituted C₆H₄ or para-substituted form;
A is identical or different and is represented by CₓH₂ₓ where x=2, 3, 4 and/or 5 and/or CH₂CH(C₆H₅);
n is identical or different and is represented by 0, 1, 2, 3, 4 and/or 5;
L is identical or different and is represented by CₓH₂ₓ where x=2, 3, 4 and/or 5 and/or CH₂—CH(C₆H₅);
a is identical or different and is represented by an integer from 2 to 350;
d is identical or different and is represented by an integer from 1 to 350;
R¹⁹ is identical or different and is represented by H and/or a straight-chain C₁-C₄ alkyl group or a branched C₃-C₄ alkyl group,
R²⁰ is identical or different and is represented by H and/or a straight-chain C₁-C₄ alkyl group.

7. Process according to claim 1, wherein the polyether macromonomer used is alkoxylated hydroxybutyl vinyl ether and/or alkoxylated diethylene glycol monovinyl ether and/or alkoxylated isoprenol and/or alkoxylated (meth)allyl alcohol and/or vinylated methylpolyalkylene glycol.

8. Process according to claim 1, wherein the free radical polymerization initiator used is an H₂O₂— or alkali metal peroxodisulphate-containing redox initiator system which is used together with a reducing agent, the temperature of the aqueous medium during the polymerization being adjusted to 5 to 43° C. and the temperature of the aqueous medium being not more than 28° C. at the beginning of the polymerization.

9. Process according to claim 1, wherein the aqueous medium is present in the form of an aqueous solution.

10. Process according to claim 1, wherein altogether at least 45 mol % of all structural units of the copolymer are produced by incorporation of acid monomer and polyether macromonomer in the form of polymerized units.

11. Process according to claim 1, wherein a chain-transfer agent is used.

12. Copolymer prepared by the process according to claim 1.

13. Process comprising adding the copolymer according to claim 12 as a dispersant to an aqueous slurry of hydraulic binder and/or to an aqueous slurry of latently hydraulic binder.

14. Process according to claim 11, wherein the chain-transfer agent comprises thiol groups.

15. Process according to claim 8, wherein the reducing agent comprises sodium sulphite, disodium salt of 2-hydroxy-2-sulphinatoacetic acid, disodium salt of 2-hydroxy-2-sulphonatoacetic acid, sodium hydroxymethanesulphinate, ascorbic acid and/or isoascorbic acid.

16. Process according to claim 1, wherein the polyether macromonomer used is alkoxylated hydroxybutyl vinyl ether and/or alkoxylated diethylene glycol monovinyl ether and/or alkoxylated isoprenol and/or alkoxylated (meth)allyl alcohol and/or vinylated methylpolyalkylene glycol having in each case an arithmetic mean number of 4 to 300 oxyalkylene groups.

17. Process according to claim 1, wherein altogether at least 80 mol % of all structural units of the copolymer are produced by incorporation of acid monomer and polyether macromonomer in the form of polymerized units.

18. Process according to claim 1, wherein the at least 70% by weight of the water which is initially taken in the polymerization reactor and is provided is taken from naturally occurring ground water.
